(19) United States
(12) Patent Application Publication
(10) Pub. No.: US 2014/0202700 A1
(43) Pub. Date: Jul. 24, 2014

(54) BIODEGRADABLE OIL EXTERNAL EMULSION FOR REMOVAL OF ASPHALTENE AND/OR PARAFFIN FROM PRODUCING OIL WELLS

(71) Applicant: Cecil Curtis Blair, Powderhorn, CO (US)

(72) Inventor: Cecil Curtis Blair, Powderhorn, CO (US)

(73) Assignee: CUDD PRESSURE CONTROL, INC., The Woodlands, TX (US)

(21) Appl. No.: 13/748,941

(22) Filed: Jan. 24, 2013

(51) Int. Cl. C09K 8/524; E21B 37/06

(52) U.S. Cl. CPC C09K 8/524; E21B 37/06
USPC 166/304; 507/203; 507/267

(57) ABSTRACT

A biodegradable and environmentally friendly oil external emulsion for the removal of asphaltenes, paraffin's, and/or scales which accumulate in the well bores and walls of the pipes used to bring the oil up from the underground deposits, and methods of using and formulating the composition are disclosed. The emulsion comprises oil extracted from orange peels as the external continuous phase and acid as the internal phase. The emulsion has a particular utility in cleaning asphaltenes and paraffin residues from the well formation surface, well cuttings, and down hole and surface oil well drilling and production equipment.

### CROSS REFERENCE TO RELATED APPLICATIONS

This application claims priority to U.S. Provisional Patent Application No. 61/589,977, filed on Jan. 24, 2012, the entirety of which is incorporated herein by reference.

### BACKGROUND OF THE INVENTION

Paraffin and/or asphaltene and scale formation in oil wells, and particularly those wells producing high-paraffin containing oils, significantly interferes with effectiveness and efficiencies of the well production and in transmission of crude oil through pipelines. In severe cases, the presence of asphaltene, paraffin, and/or scale formation can, in essence cause the oil production for a given well to cease. A variety of mechanical, chemical, electrical heating, and magnetic systems have been proposed in the prior art to combat this problem. However, the prior art methods are fraught with problems. Therefore, there is currently a need to develop new methods and systems for removal of paraffin, asphaltene, and/or scale formation that are economical, efficient, and effective, involve no downtime, and are easy to use.

### BRIEF SUMMARY OF THE INVENTION

In some embodiments, the present disclosure provides a process for removing asphaltenes and/or paraffins and scale from an oil well comprising the step of: contacting, with the interior of the oil well, a biodegradable oil external emulsion comprising: a liquid mixture of an external continuous phase of distilled, stabilized oil extracted from orange peels; an internal discontinuous phase; a first emulsifier; and a second emulsifier; where the contact is for a period of time sufficient to remove asphaltenes, paraffins, and/or scale within the well from the openings. In another embodiment of the present disclosure the process further comprises the step of pumping the biodegradable composition and the removed asphaltenes, paraffins, and/or scale to the surface through the wellbore. Preferably, the stabilized oil extracted from orange peels is d-limonene. Desirably the internal discontinuous phase is an acid. Moreover, in an embodiment of the present disclosure the process, removes the asphaltenes and/or paraffins and scale deposit simultaneously.

Further embodiments of the present disclosure pertain to a biodegradable oil external emulsion composition for the removal of asphaltenes, paraffins and/or scale deposits comprising: a mixture of an external continuous phase of distilled, stabilized oil extracted from orange peels; an internal discontinuous phase; a first emulsifier; and a second emulsifier. Desirably, the biodegradable composition does not contain aromatic solvents. Preferably, the distilled, stabilized oil extracted from orange peels is d-limonene. Desirably, the internal discontinuous phase is an acid. Moreover, the biodegradable oil external emulsion composition removes the asphaltene and/or paraffin deposits simultaneously.

Additional embodiments of the present disclosure pertain to a method of formulating a biodegradable oil external emulsion composition for the removal of asphaltenes, paraffins and/or scale deposits comprising: measuring an external continuous phase of distilled, stabilized oil extracted from orange peels and placing it in a homogenizer; measuring and adding a first emulsifier to the homogenizer with continuous agitation; measuring and adding a second emulsifier to the homogenizer with continuous agitation; measuring and adding an internal discontinuous phase to the homogenizer with continuous agitation; and continuing the agitation till the composition is stable. Preferably, the distilled, stabilized oil extracted from orange peels is d-limonene. Desirably, the internal discontinuous phase is an acid.

As set forth in more detail herein, the methods and compositions of the present disclosure provide numerous improvements in removing asphaltenes and/or paraffins and scale simultaneously from an oil well containing clogged perforations or openings.

### BRIEF DESCRIPTION OF THE FIGURES

FIG. 1A-1D depicts an exemplary embodiment of the method of formulating the biodegradable composition at the sub-surface formation or the well location. FIG. 1A shows a transport carrying the predetermined volume of orange peel oil premixed with the emulsifiers, and/or other additives (e.g., viscosity promoters). FIG. 1B depicts the transport carrying the required amount of acid at the proper concentration pre-mixed with additives (e.g., inhibitors, surfactant, and viscosity promoters). FIG. 1C is the centrifugal pump truck into which the providing the shear rate required to formulate the emulsion and provide the high pressure positive displacement pump to inject the emulsion into the well. FIG. 1D is the wellhead into which the fluid is injected.

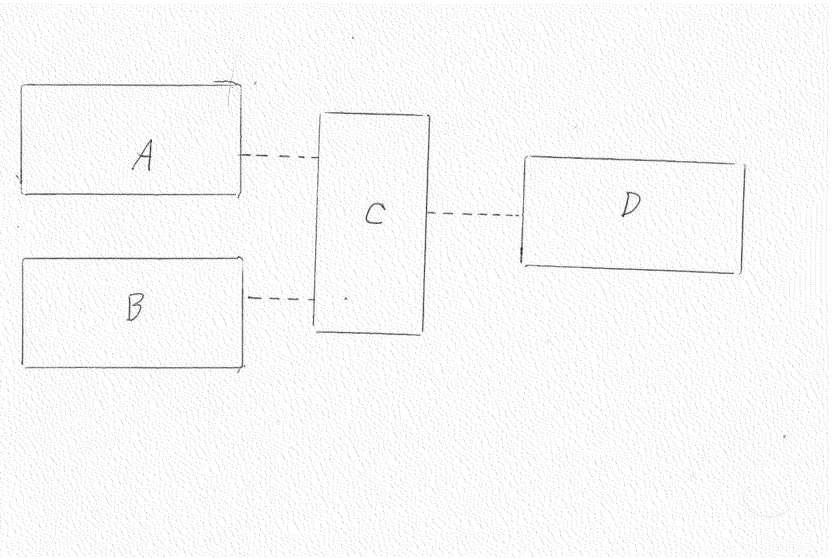

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass either elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

The buildup of paraffin and asphaltene in oil wells is a problem in the oil industry. Generally, the paraffin and/or asphaltene crystallizes out of and solidifies in the well bore, the area surrounding the well bore, the casing and tubing of the well thereby reducing or blocking further production. If not removed, these accumulations may eventually build up to the point that the flow of the oil is significantly reduced and the well becomes inoperable.

Asphaltenes are heterocyclic unsaturated macromolecules consisting primarily of carbon, hydrogen, and minor components such as sulfur, oxygen, nitrogen, and various heavy metals. These high-molecular-weight components of crude oil are in equilibrium under normal reservoir conditions. As crude oil is produced, this equilibrium may be upset by a number of factors, such as CO₂ and rich-gas injection, pH shift, pressure drop, shear, streaming potential through porous media and charge metal surfaces, leading to asphaltene deposition. Asphaltene deposition can occur anywhere in the production life cycle: in the near-wellbore region including perforations, in the tubing, downhole and surface chokes, and surface flowlines. Predicting where asphaltene deposition might occur requires an understanding of the mechanisms for asphaltene deposition. The key causes are pressure decrease and injection of incompatible fluids in the reservoir rocks. Asphaltene problems can significantly reduce well productivity, causing troublesome operational issues, damaging formations, and decreasing production. A most common asphaltene removal technique uses xylene or xylene mixtures which typically have undesirable health, safety, and environmental effects.

Also, paraffin accounts for a significant portion of a majority of crude oils that are greater than 20° API (American Petroleum Institute degrees). Paraffin has a straight chain linear structure comprised entirely of carbon and hydrogen. The paraffins with molecules that are larger than C₂₀H₄₂ are the components that cause deposition or congealing oil in crude oil systems. Paraffin can deposit from formation pores to the pipeline that deliver oil to the refineries. The deposits vary in consistency from rock hard for the highest chain-length paraffin to very soft, mayonnaise-like congealing oil deposits. Paraffin (wax) is mostly found as a white, odorless, tasteless, waxy solid, with a typical melting point ranges from 47° C. to 64° C. (116.6° F. to 147.2° F.), and a density of around 0.9 g/cm³. It is insoluble in water, but soluble in ether, benzene, and certain esters.

In the past, attempts have been made to remove the paraffin and/or asphaltene by mechanically cutting it out of the well or using the so-called “hot-oiling” technique. The mechanical cutting process is relatively a crude procedure and requires extensive well shutdown time. Moreover, it is extremely inefficient inasmuch as substantial amounts of paraffin and asphaltene remain in the well. The remaining paraffin and/or aspahltene provide seed crystals which promote the rapid formation of additional paraffin and/or asphaltene. With the hot-oiling method, the produced crude is heated to a temperature well above the melting point of the paraffin and/or asphaltene and is then circulated through the annulus of the well and returned to a hot-oil heating truck through production tubing. The purpose here is for the hot oil to melt and dissolve the paraffin so that it can be removed from the well in a liquid form. However, this technique is expensive and can be dangerous, particularly with wells producing crude having a low flash point, as this creates a possibility of well explosion. Another procedure that is commonly used is the “hot-acid” technique. In this method a combination of hot water, heated xylene and hot acid is used to melt the paraffin. However, this method is also not satisfactory as it works for removal of carbonate scale but not for paraffin and/or asphaltene removal. Most of prior art methods may use numerous steps to remove paraffin, asphaltene, sludge, and/or scale from the wells and these multistep procedures are inefficient and expensive.

Solvency has been the key for removing these deposits. A number of factors can affect the removal of paraffin from production systems. Some of these factors are: type of solvent used, type of paraffin, quantity of paraffin, temperature and contact time. Any or all of these can help determine success or failure of a paraffin removal treatment. Different solvents have different abilities to dissolve paraffin. Two general classes of solvents used in the oilfield to dissolve paraffin are aliphatic and aromatic. Common aliphatic solvent used in the oilfield are diesel, kerosene, and condensate. Aromatic solvent used are xylene and toluene. Among all the solvents, xylene and toluene are more effective than aliphatic solvents in removing most of the paraffin deposits. Traditionally, aromatic solvents such as xylene and toluene have been used to remove damaging organic deposits such as asphaltene and/or paraffin from wellbore tubulars and the formation matrix. However, governmental regulations on the usage, disposal and volatile emission-limits of aromatic solvents are becoming increasingly restrictive. Solvents with benzene, ethyl benzene, toluene and xylene (BETX) are encountering stiff resistance due to environmental concerns and government regulations. These problems are especially acute for offshore applications. Practically, the flammability, acute toxicity, and environmental contamination concerns have made their use less attractive.

A replacement for aromatic solvents in the oilfield is needed that is more logistically and operationally efficient as well as more socially and environmentally responsible. A fluid that is effective, environmentally favorable, and low cost is desirable.

The present disclosure provides a biodegradable composition and a process for the removal of asphaltenes and hydrochloric acid soluble solids simultaneously from sub-surface formations using the biodegradable composition. The biodegradable composition of the present disclosure minimizes health concerns and increases safety by having a much higher flash point. Additionally, the biodegradable composition of the present disclosure is environmentally friendly due to the elimination of aromatic compounds from the composition.

The biodegradable composition of the present disclosure comprises oil extracted from orange peels, a terpene, as an external continuous phase, an acid as an internal phase and two emulsifiers used to create an emulsion with the oil and to provide stability. The terpene is a terpene hydrocarbon. The preferred specific terpene is D-limonene, a biodegradable product derived from orange rind oil. The acid may be acetic acid, sulfuric acid or hydrochloric acid. Preferably, the acid may be hydrochloric acid. In some embodiments the orange peel oil may form from about 15% to about 35% of the composition by volume. In the some embodiment the acid may comprise from about 65% to about 85% of the biodegradable composition by volume. Additionally, in some embodiments, the emulsifiers may comprise from about 0.1% to about 1.5% of volume of oil.

A wide variety of cationic emulsifiers may be used for formulating the biodegradable composition of the present disclosure. Some examples of cationic emulsifiers include fatty acid esters and quaternary amines.

Various nonessential components may be added to the biodegradable composition of the present disclosure. These may be selected from the usual components employed such as preservatives, anti-foaming agents, viscosity promoters, weighing agents, polymers and the like, provided the biodegradable composition retains its form and activity when these agents are added.

The emulsion of the present disclosure may be formed by conventional methods, such as with the use of homogenizer, with the application of shear. Any centrifugal pump able to provide sufficient shear to create the emulsion can be used to make the biodegradable composition of the present disclosure. In an exemplary embodiment, the orange peel oil is measured and placed in a homogenizer. Measured volumes of emulsifiers are then added to the homogenizer while agitating the mixture. Water is measured and added to the mixture according to the desired concentration of hydrochloric acid. Finally, hydrochloric acid is measured and added to the mixture and the mixture is homogenized until it is stable. The stability and half-life of the emulsion can be varied from half-an hour to 24 hours by changing the volume and ratio of emulsifier.

In an embodiment of the present disclosure there is provided a biodegradable oil external emulsion composition for the removal of asphaltenes, paraffins and/or scale deposits comprising: a mixture of an external continuous phase of distilled, stabilized oil extracted from orange peels; an internal discontinuous phase; a first emulsifier; and a second emulsifier. In some embodiments, the distilled, stabilized oil may comprise from about 15% to about 35% of the biodegradable composition by volume. In an embodiment the internal discontinuous phase may comprise from about 65% to about 85% of the biodegradable composition by volume. Further, in another embodiment of the present invention the internal discontinuous phase may comprise acid. In some embodiments the acid may be acetic acid, hydrochloric acid or sulfuric acid. Preferably, in an embodiment of the present disclosure the acid is hydrochloric acid. Additionally, in some embodiments of the present disclosure, the hydrochloric acid may comprise from about 3% to about 28%; of the biodegradable composition by volume. Moreover, in another embodiment of the present disclosure the first emulsifier may comprise from about 0.1 to about 1.5% by volume of the distilled, stabilized oil extracted from orange peels. In an embodiment, of the present disclosure, the second emulsifier may comprise from about 0.1 to about 1.5% by volume of the distilled, stabilized oil extracted from orange peels. In an embodiment of the present disclosure the stability of the biodegradable composition is varied by changing the volume or ratio of the first or second emulsifier. In some embodiments the first and the second emulsifier is a cationic emulsifier. In another embodiment the asphaltenes and/or paraffins and scale deposit are removed simultaneously. Further, in an embodiment of the present disclosure the biodegradable composition may not comprise of aromatic solvents.

Various methods may be used to remove asphaltene and/or paraffin deposits from a portion of equipment or a subterranean formation using the biodegradable composition of the present disclosure. Such methods may include pre-flush of fracturing jobs with the biodegradable composition, and continuous downhole injection of the biodegradable composition of the present disclosure. Additionally, methods to remove deposits also include the following: introducing the biodegradable composition of the present disclosure into a well including placing in the portion of the well to be treated via production tubing for a sufficient contact time for the biodegradable composition to dissolve a substantial amount of organic deposits (i.e., paraffin and asphaltenes). A pump injector or any other suitable tool(s) may be used to introduce the biodegradable composition of the present disclosure into a well. A soak time may be needed. The method also includes flowing back the biodegradable composition to the surface through the wellbore after placing the composition and subsequent soak time.

The length of soak time and the volume of the biodegradable composition required to remove asphaltenes and/or paraffin deposits may be empirically determined based on the length of time the well has been operational, the type of formation, other contaminants that may be present, the total depth of the well and the well configuration.

Additionally, in some embodiments of the present disclosure the biodegradable composition disclosed may be pumped via coiled tubing with a downhole nozzle placed in a portion of a well to be treated. In an embodiment of the present disclosure the biodegradable composition is allowed to soak for a sufficient time for it to blend to dissolve a substantial amount of organic deposits (i.e., paraffin and asphaltenes). In another embodiment of the present invention, the biodegradable composition is allowed to flow back to the surface either through the coiled tubing or by circulating it out.

In another embodiment of the present disclosure, an engineered, high pressure bottom hole assembly may be used in combination with a coiled tubing assembly to deliver the biodegradable composition. The biodegradable composition is allowed to soak for a sufficient time for it to dissolve a substantial amount of organic deposits (i.e., paraffin and asphaltenes). Next, the biodegradable composition is allowed to flow back to the surface either through the coiled tubing or by circulating it out.

In some embodiments of the present disclosure, the biodegradable composition is injected continuously through micro-coiled tubing permanently installed in wellbores. Continued injection of the biodegradable composition at downhole conditions will inhibit the precipitation of paraffin and asphaltene on the tubulars.

In some embodiments, the biodegradable composition may have a wide variety of applications as solvent for asphaltene and/or paraffin and scale deposits. Some of these include: wellbore and tubing clean-out using an injector tool, cleaning flowlines and tanks, and formation cleaning. Furthermore, in an embodiment of the present disclosure, the biodegradable composition is used to clean asphaltenes and/or paraffins and scale deposits form clogged perforations or openings of a pumping oil well. In another embodiment, the asphaltenes and/or paraffins and scale form deposits on down hole well drilling equipment.

The biodegradable composition acts to remove the asphaltenes and/or paraffins and scale formation by entering the sub-surface formation where the oil phase of the biodegradable composition acts to remove the asphaltene and paraffinic residues from the formation surfaces thereby allowing the hydrochloric acid to contact and react with the acid soluble materials, including scale and formation material.

In an embodiment of the present disclosure, there is provided a process for removing both asphaltenes and/or paraffins and scale from an oil well or a sub-surface formation comprising the step of: contacting with the interior of the oil well, a biodegradable oil external emulsion, where the biodegradable oil external emulsion comprises: a liquid mixture of an external continuous phase of distilled, stabilized oil extracted from orange peels an internal discontinuous phase; a first emulsifier; and a second emulsifier; where the contact is for a period of time sufficient to remove asphaltenes, paraffins, and/or scale within the well from the openings. In an embodiment the process may further comprise pumping the biodegradable oil external emulsion with the removed asphaltenes, paraffins, and/or scale out of the well. In an embodiment of the present disclosure, the distilled, stabilized oil may comprise from about 15% to about 35% of the composition by volume. In another embodiment the internal discontinuous phase may comprise from about 65% to about 85% of the composition by volume. Further, in an embodiment of the present disclosure the internal discontinuous phase may comprise acid. In some embodiments the acid may be acetic acid, hydrochloric acid or sulfuric acid. In an embodiment of the present disclosure the acid is hydrochloric acid. Additionally, in some embodiments of the present disclosure, the hydrochloric acid may comprise from about 3% to about 28%; of the composition by volume. Moreover, in an embodiment of the present disclosure the first emulsifier may comprise from about 0.1 to about 1.5% by volume of the distilled, stabilized oil extracted from orange peels. Further, in another embodiment the second emulsifier may comprise from about 0.1 to about 1.5% by volume of the distilled, stabilized oil extracted from orange peels. In an embodiment of the present disclosure the stability of the biodegradable composition is varied by changing the volume or ratio of the first or second emulsifier. In some embodiments the first or the second emulsifier is a cationic emulsifier. In another embodiment the asphaltenes and/or paraffins and scale deposit are removed simultaneously. Furthermore, in an embodiment of the present disclosure, the asphaltenes and/or paraffins and scale deposits form clogged perforations or openings of a pumping oil well. In another embodiment of the present disclosure, the asphaltenes and/or paraffins and scale form deposits on downhole well drilling equipment.

In another embodiment of the present disclosure there is provided a method of removing paraffin and asphaltene deposits in a pumping oil well comprising contacting with the interior of the oil well a biodegradable oil external emulsion comprising: a liquid mixture of an external continuous phase of distilled, stabilized d-limonene; an internal discontinuous phase; a liquid mixture of an external continuous phase of distilled, stabilized d-limonene; an internal discontinuous phase; a first emulsifier; and a second emulsifier; wherein the contact is for a period of time sufficient to remove asphaltenes, paraffins, and/or scale within the well from the openings; and). Pumping the biodegradable composition and the removed asphaltenes, paraffins, and/or scale to the surface.

In another embodiment of the present disclosure there is provided a method of formulating a biodegradable oil external emulsion composition for the removal of asphaltenes, paraffins and/or scale deposits comprising: measuring an external continuous phase of distilled, stabilized oil extracted from orange peels and placing it in a homogenizer; measuring and adding a first emulsifier to the homogenizer with continuous agitation; measuring and adding a second emulsifier to the homogenizer with continuous agitation; measuring and adding an internal discontinuous phase to the homogenizer with continuous agitation; and continuing the agitation till the composition is stable. In some embodiments the distilled, stabilized oil extracted from orange peels comprises from about 15% to about 35% of the composition by volume. Further, the first emulsifier comprises from about 0.1 to about 1.5% by volume of the distilled, stabilized oil extracted from orange peels. In a related embodiment the second emulsifier comprises from about 0.1 to about 1.5% by volume of the distilled, stabilized oil extracted from orange peels. Moreover, the internal discontinuous phase comprises from about 65% to about 85% of the composition by volume. Further, in an embodiment of the present disclosure the internal discontinuous phase is an acid. In some embodiments the acid may be acetic acid, hydrochloric acid or sulfuric acid. In an embodiment of the present disclosure the acid is hydrochloric acid. In an embodiment, water is measured and added according to the desired acid concentration in the composition. In a related embodiment the hydrochloric acid comprises from about 3% to about 28%; of the composition by volume. In some embodiments the first or the second emulsifier is a cationic emulsifier. In an embodiment of the present disclosure the stability of the biodegradable composition is varied by changing the volume or ratio of the first or second emulsifier. In another embodiment the biodegradable composition removes the asphaltenes and/or paraffins and scale deposit simultaneously.

Any centrifugal pump able to provide sufficient shear to create the emulsion can be used to make the biodegradable composition of the present disclosure. In an embodiment the oil extracted from orange peels and the first and second emulsifiers are pre-mixed and brought to the sub-surface formation or well location in a transporter. Various other additives, like viscosity promoters, may be added to the pre-mixed oil and emulsifiers. The acid mixed with additives like inhibitors, surfactant, and viscosity promoters, is transported to the sub-surface formation or well location in a separate transporter. The pre-mix of oil extracted from orange peels and the first and second emulsifiers are poured into the centrifugal pump from the transporter and the acid is then added to the centrifugal pump to create the biodegradable composition. In another embodiment the centrifugal pump containing the biodegradable composition is attached to an injector pump and the composition is injected into the sub-surface formation. In some embodiments the biodegradable composition is formulated in accordance with the method disclosed above and then brought to the sub-surface formation or well location.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A process for removing asphaltenes and/or paraffins and scale from an oil well or a sub-surface formation comprising the steps of:
(a) contacting with the interior of the oil well a biodegradable oil external emulsion comprising:
(i) a liquid mixture of an external continuous phase of distilled, stabilized oil extracted from orange peels;
(ii) an internal discontinuous phase;
(iv) a first emulsifier; and
(v) a second emulsifier; wherein the composition does not contain any aromatic solvents;
wherein the contact is for a period of time sufficient to remove asphaltenes, paraffins, and/or scale within the well from the openings; and
(b) Pumping the biodegradable composition and the removed asphaltenes, paraffins, and/or scale to the surface.

2. The process of claim 1, wherein the distilled, stabilized oil comprises from about 15% to about 35% of the composition by volume.

3. The process of claim 1, wherein the internal discontinuous phase comprises from about 65% to about 85% of the composition by volume.

4. The process of claim 1, wherein the internal discontinuous phase comprises an acid.

5. The process of claim 4, wherein the acid is sulfuric acid, acetic acid or hydrochloric acid.

6. The process of claim 4, wherein the acid is hydrochloric acid.

7. The process of claim 6, wherein the hydrochloric acid comprises from about 3% to about 28%; of the composition by volume.

8. The process of claim 1, wherein the first emulsifier comprises from about 0.1 to about 1.5% by volume of the distilled, stabilized oil extracted from orange peels.

9. The process of claim 1, wherein the second emulsifier comprises from about 0.1 to about 1.5% by volume of the distilled, stabilized oil extracted from orange peels.

10. The process of claim 1, wherein the first or the second emulsifier are cationic emulsifiers.

11. The process of claim 1, wherein the stability of the biodegradable composition is varied by changing the volume or ratio of the first or the second emulsifier.

12. The process of claim 1, wherein the contacting comprises injecting the biodegradable oil external emulsion into the oil well via the production tubing.

13. The process of claim 1, wherein the asphaltenes and/or paraffins and scale deposit are removed simultaneously.

14. A method of removing paraffin and asphaltene deposits in pumping oil well comprising:
(a) contacting with the interior of the oil well a biodegradable oil external emulsion comprising:
(i) a liquid mixture of an external continuous phase of distilled, stabilized d-limonene;
(ii) an internal discontinuous phase;
(iv) a first emulsifier; and
(v) a second emulsifier; wherein the contact is for a period of time sufficient to remove asphaltenes, paraffins, and/or scale within the well from the openings; and
(b). Pumping the biodegradable composition and the removed asphaltenes, paraffins, and/or scale to the surface.

15. A biodegradable oil external emulsion composition for the removal of asphaltenes, paraffins and/or scale deposits comprising:
a mixture of an external continuous phase of distilled, stabilized oil extracted from orange peels;
an internal discontinuous phase;
a first emulsifier; and
a second emulsifier.

16. The biodegradable composition of claim 15, wherein the distilled, stabilized oil comprises from about 15% to about 35% of the composition by volume.

17. The biodegradable composition of claim 16, wherein the distilled, stabilized oil is d-limonene.

18. The biodegradable composition of claim 15, wherein the internal discontinuous phase comprises from about 65% to about 85% of the composition by volume.

19. The biodegradable composition of claim 15, wherein the internal discontinuous phase comprises acid.

20. The biodegradable composition of claim 19, wherein the acid is sulfuric acid, acetic acid or hydrochloric acid.

21. The biodegradable composition of claim 19, wherein the acid is hydrochloric acid.

22. The biodegradable composition of claim 21, wherein the hydrochloric acid comprises from about 3% to about 28%; of the composition by volume.

23. The biodegradable composition of claim 15, wherein the first emulsifier comprises from about 0.1 to about 1.5% by volume of the distilled, stabilized oil extracted from orange peels.

24. The biodegradable composition of claim 15, wherein the second emulsifier comprises from about 0.1 to about 1.5% by volume of the distilled, stabilized oil extracted from orange peels.

25. The biodegradable composition of claim 15, wherein the first or the second emulsifier are cationic emulsifiers.

26. The biodegradable composition of claim 15, wherein the stability of the biodegradable composition is varied by changing the volume or ratio of the first or the second emulsifier.

27. The biodegradable composition of claim 15, wherein the composition removes the asphaltenes and/or paraffins and scale deposit simultaneously.

28. A method of formulating a biodegradable oil external emulsion composition for the removal of asphaltenes, paraffins and/or scale deposits comprising:
measuring an external continuous phase of distilled, stabilized oil extracted from orange peels and placing it in a homogenizer;
measuring and adding a first emulsifier to the homogenizer with continuous agitation;
measuring and adding a second emulsifier to the homogenizer with continuous agitation;
measuring and adding an internal discontinuous phase to the homogenizer with continuous agitation; and
continuing the agitation till the composition is stable.

29. The method of claim 28, wherein the distilled, stabilized oil extracted from orange peels comprises from about 15% to about 35% of the composition by volume.

30. The method of claim 28, wherein the first emulsifier comprises from about 0.1 to about 1.5% by volume of the distilled, stabilized oil extracted from orange peels.

31. The method of claim 28, wherein the second emulsifier comprises from about 0.1 to about 1.5% by volume of the distilled, stabilized oil extracted from orange peels.

32. The method of claim 28, wherein the internal discontinuous phase comprises from about 65% to about 85% of the composition by volume.

33. The method of claim 28, wherein the internal discontinuous phase is an acid.

34. The method of claim 33, wherein the acid is sulfuric acid, acetic acid or hydrochloric acid.

35. The method of claim 33, wherein the acid is hydrochloric acid.

36. The method of claim 35, wherein the hydrochloric acid comprises from about 3% to about 28%; of the composition by volume.

37. The method of claim 28, wherein the stability of the biodegradable composition is varied by changing the volume or ratio of the first or the second emulsifier

38. The method of claim 28, wherein the asphaltenes and/or paraffins and scale deposits form clogged perforations or openings of a pumping oil well.

39. The method of claim 38, wherein the removal of the asphaltenes and/or paraffins and scale deposit occurs simultaneously.
